(19) United States
(12) Patent Application Publication
(10) Pub. No.: US 2014/0217034 A1
(43) Pub. Date: Aug. 7, 2014

(54) Compositions for Conditioning Sludge

(71) Applicant: S. A. Lhoist Recherche et Developpement, Ottignies-Louvain-La-Neuve (BE)

(72) Inventors: Laurent Biotteau, Saint Christo en Jarez (FR); Gaetan Blandin, Maulevrier (FR); Hubert Charbonnier, Vourles (FR); Tamer Ozturk, La Louviere (BE)

(73) Assignee: S. A. Lhoist Recherche et Developpement, Ottignies-Louvain-La-Neuve (BE)

(21) Appl. No.: 14/246,564

(22) Filed: Apr. 7, 2014

Related U.S. Application Data
(62) Division of application No. 12/826,038, filed on Jun. 29, 2010.

(51) Int. Cl. C02F 11/14

(52) U.S. Cl. CPC C02F 11/14
USPC 210/728; 252/181

(57) ABSTRACT

Composition for conditioning sludge, comprising a mineral compound that is lime and an organic compound that is a cationic organic coagulant having an average molecular weight less than or equal to 5 million g/mol and greater than or equal to 20,000 g/mol, the said cationic organic coagulant being chosen from the group of linear or branched polymers based on diallyldialkyl ammonium salts.

### 1. CROSS REFERENCE TO RELATED APPLICATIONS

The present application is a divisional of prior filed Ser. No. 12/826,038, filed Jun. 29, 2010, entitled “Compositions For Conditioning Sludge”, by the same inventors.

### 2. FIELD OF THE INVENTION

The present invention relates to a composition for conditioning sludge, comprising a mineral compound and an organic compound, said mineral compound being lime and said organic compound being selected from the group consisting of linear or branched polymers based on diallyl dialkyl ammonium salts.

### 3. DESCRIPTION OF THE RELATED ART

Compositions for treating sludge are known in particular from the document EP 1 104 904 (U.S. Pat. No. 4,711,727), which discloses the use of differet mineral compounds, in association with various organic polymers. However, according to the teaching of this document, the organic polymer has a dispersing action making it possible to produce concentrated suspensions of mineral compounds having an acceptable viscosity with a view to pump the aformentioned composition.

The document U.S. Pat. No. 4,675,114 also discloses a method of treating sludge by a sequential addition of a mineral compound and an organic compound among many successive steps.

Towns, in particular large cities, and industries, produce or discharge very large volumes of waste water. The treatment of this water, before discharge thereof into the natural environment, results in the formation of very large quantities of sludge. A step of mechanical dewatering is generally necessary in order to reduce to its minimum the volume occupied by the sludge, whatever the origins thereof, and to increase the dryness thereof before the agricultural recycling thereof or by incineration or composting or before elimination thereof by storage in land fill. This dewatering, that is to say the solid/liquid separation, is performed in the majority of cases by means of a belt filter, or a filter press or a centrifugal machine that usually combine chemical conditioning applied upstream of a mechanical action. Apart from the reduction in volume, the purpose of this treatment is to facilitate the handling, transportation and storage of this sludge.

The present invention concerns particularly the sludge conditioning by means of a mineral and organic compound. The term “sludge”, within the meaning of the invention, means a residue having a level of dry matter of at least 0.5%, often greater than or equal to 1%. The sludge may be mineral or organic or oily.

The concept of conditioning, in particular chemical conditioning, must be understood within the meaning of the present invention as defined by Degrémont in “Memento Technique de l'eau, Edition du Cinquantenaire 1989, 9^{th} edition” in chapter 19, in particular on pages 949 to 959.

To get sludge ability to filtration, it is first necessary to break the colloidal cohesion of the sludge and artificially increase the size of the particles that make it up. This is the purpose of the conditioning. Suitable conditioning of the sludge is the basis of the correct functioning of the dewatering plant. The conditioning should therefore be optimised in order to be adapted both to the nature of the sludge to be treated but also to the type of dewatering equipment.

The conditioning of the sludge is therefore in reality a treatment in which the characteristics of the sludge are modified in order to facilitate the separation of the solid phase and liquid phase.

Unlike a water treatment process (see for example the document U.S. Pat. No. 4,711,727) the principle of which consists of causing, via the addition of flocculent and/or coagulant, the agglomeration and settling of the colloidal particles, the conditioning of sludge aims to prepare the latter to enable the correct functioning of the mechanical dewatering equipment by eliminating in particular the problems of squeezing, clogging of cloths and sticking of cake. The conditioning of the sludge therefore consists of a particular application of coagulation/flocculation. The purpose thereof is to increase dryness (dry matter content) by accelerating solid/liquid separation.

Moreover, the document U.S. Pat. No. 4,711,727 discloses the conjoint use of mineral suspensions that may contain lime and, indifferently, flocculent and/or coagulant, in order to flocculate the waste water, containing matter in suspension to the extent of approximately 300 mg/l (0.03%), and in particular teaches carrying out prior dilutions of the aforementioned mineral suspensions.

Three technologies are most frequently used as mechanical dewatering systems in sludge conditioning installations.

### Belt Press Filters

On this type of filter, the sludge being conditioned is first of all dewatered and then compressed between two filter cloths. The system of advancement and compression of the cloths is provided by rolls. This type of tool requires consistent and well dissociated flocks, promoting rapid release of water during the dewatering step.

### Centrifugal Machines or Centrifuges

These systems use centrifugal force to cause accelerated settling. Good separation will assume forming a bulky heavy flock, resistant to shearing.

### Filter Presses (Or Chamber Filter Presses)

Unlike the above systems, this tool functions discontinuously, by batch. A filter press consists of plates covered with filter cloths, disposed in a battery, with chambers and/or membrane. The chambers provided between each plate are fed with conditioned sludge by means of a pump. This sludge pump feeds the chambers (supercharging operation) until a high pressure is obtained, generally between 10 and 15 bar. At the end of the cycle, the plates are separated in order to discharge the cakes formed. It is highly desirable for the cakes thus formed to remain relatively firm and in particular to become cleanly detached from the plates and cloths; in the other case, manual intervention for cleaning and washing are necessary. In the case of the filter press, a processing robust to stresses (in particular pressure) will be sought.

Among the various chemical conditioning operations aimed at preparing the sludge, there are in particular organic conditioning and mineral conditioning should be in particular, distinguished.

The so-called organic conditioning: use of organic polymer as the only flocculent (typical dosage 2 to 20 kg per tonne of dry matter). Only long-chain synthetic polyelectrolytes (high molecular weights, in particular based on acrylamide) are effective; they form voluminous and well differentiated flocks in a clarified interstitial water. This processing is in particular used in dewatering on a centrifuge and belt filters. It is rarely used during mechanical dewatering by filtration under pressure (mechanised filter press) since it leads to a longer press time, because of the high specific strength, frequent washing of the cloths and less good cake discharge.

So-called mineral conditioning: conjoint use of an iron or aluminium salt, such as ferric chloride (typical dosage: 3% to 10% by weight with respect to the dry matter being treated) and lime (typical dosage: 10% to 40% by weight with respect to the dry matter being treated). This conditioning mode produces a fine flock but one that is very robust to stresses; it will therefore be particularly suited to filtration on a filter press. Nevertheless the use of iron salts is not without its problems in use such as: corrosion of steel or cast iron pipes and filters, the presence of chlorides in a high proportion, the presence of iron which, when the sludge is incinerated, gives rise to the production of slag, and the risk of burns for personnel.

There also exist mixed conditioning operations (mineral and organic) in order to optimise the dewatering performance.

As can be seen, all the above processing methods have drawbacks. Organic conditioning is not the best suited to certain dewatering systems such as filter presses; the other conditioning methods mentioned have recourse in particular to iron salts that pose the numerous aforementioned problems.

Yet another possibility of mixed conditioning is disclosed in the document EP 1 154 958. The method disclosed teaches an addition of lime to industrial sludge, chosen to prevent the too rapid increase of the pH of the sludge to which the lime has been added. The method also provides for the addition of long-chain flocculent organic components (anionic, cationic or non-ionic, indifferently) in order to facilitate the flocculation of the sludge thus treated. Since the pH of the sludge increases in a controlled mode, the flocculating organic component can exert its flocculating activity without being degraded by an excessively rapid increase in pH.

In the document WO 2008/058973, a method of treating sludge with lime is described, according to which an anionic organic flocculent is added to the sludge, since cationic polymers in general degrade rapidly as from a pH of 9 or 10. Since the anionic flocculent has optimum activity at pHs beyond 10 to 12, it is therefore preferable to effect a rapid rise in pH, which perfectly enables lime to be added to the sludge.

Whatever the conditioning method and the reagents, used, good conditioning of the sludge assumes control of the coagulation/flocculation mechanisms, the objective being to enable the reagents to be dispersed well in the sludge without destructuring the flocculated sludge. Particular care must therefore be given to the integration of the reagents (method and order of integration), the contact and maturation time and the stress applied to the flocculated sludge.

Obtaining good results frequently requires, among other things:
the preparation of the reagents (putting the polymer or polymers in solution, manufacturing the milk of lime) in order to promote the dispersion thereof and increase their efficacy in conditioning the sludge;
successive conditioning ponds;
and/or in-line mixers.

The injection order of the reagents (the ferric chloride must be added before the lime and the polymer often last) and certain interactions between reagents (risk of flocculation of the lime by the polymer) may also be critical.

Consequently, as can be seen, the existing sludge conditioning reagents all have laborious constraints such as taking account of the addition order of the reagents, the instability of the components if added together, requiring isolation (storage, separate transport) and/or precautions in addition or the selection of specific lime, such as for example for conferring the optimum properties on the sludge so that the polymer can have its flocculating action.

### SUMMARY OF THE INVENTION

The present invention aims to overcome the aforementioned drawbacks of the prior art when conditioning sludge before dewatering, by offering a simple, safe and effective solution to the problems encountered previously. Simple through the reduction in the operations (reduction in the costs of storing the compounds, reduction in the costs of use); safe through the absence or limitation of recourse to iron salts and effective, in particular through the obtaining of strong flocks, compatible with the use of filter presses and therefore affording a high filtration efficiency (increase in the dryness (dry-matter content) of the cake obtained, acceleration of the mechanical solid/liquid separation step and reduction in the problems of squeezing, clogging of cloths and sticking of cakes).

According to the invention, it has been found surprisingly that a composition characterized in that said organic compound selected from the group consisting of linear or brached polymers based on diallyl dialkyl ammonium salts, is a cationic organic coagulant, having an average molecular weight less than or equal to 5 million g/mol and greater than or equal to 20,000 g/mol, present in a quantity ranging from 3 g to 100 g for 1 kg of lime (expressed as a slaked lime CA(OH)₂) equivalent, said composition being in the form of an homogeneous and stable mixture of lime and said coagulant before being introduced for conditioning sludge and in that said composition is in a stable suspension form, wherein said lime is slaked lime in the form of milk of lime, and forms with the said cationic organic coagulant a stable suspension that makes it possible to carry out an optimum conditioning of the sludge before the latter undergoes a mechanical dewatatering operation. This conditioning is characterized by a simplification of implementation, while affording an improvement in the filtration performance.

This is because, according to the present invention, it has been found surprisingly that the association of a particular mineral compound with a particular organic polymer in a composition allows use for the treatment of sludge, and more particularly for the conditioning of sludge, in particular urban and industrial, before the latter undergoes a mechanical dewatering operation, that is to say a composition that is firstly stable and homogeneous to facilitate storage and use thereof and which secondly reduces costs of implementation, while obtaining a high filtration efficiency. The composition according to the invention therefore makes it possible in particular to increase the dryness (dry matter content) of the cake obtained during the mechanical solid/liquid separation step.

### DETAILED DESCRIPTION OF THE INVENTION

Within the meaning of the invention, a coagulant is a compound that destabilises the constituents present in a given water or sludge and consequently allows the formation of microflocks, unlike a flocculent which agglomerates into aggregates the particles formed during destabilisation.

During coagulation by a cationic coagulant, that is to say one that is positively charged, a phenomenon of balancing of the charges of the particles in the sludge (negatively charged) will occur. This is because, in general terms, the particles in the sludge bearing a negative charge will have their charges counterbalanced by the positive charges of the cationic coagulants. The cationic coagulants will interact with several particles of the sludge and thus form microflocks.

The subject matter of the present invention is therefore compositions comprising both lime and at least one organic cationic polymer, also referred to as a coagulant, based on diallyldialkyl ammonium salts, for conditioning sludge before dewatering thereof.

Preferably the compositions according to the invention are manufactured in advance and delivered in the form of a homogeneous stable mixture of the said at least one coagulant and lime before being introduced simultaneously for the conditioning of the sludge.

Such a prior industrial manufacture of the compositions according to the invention is made possible due to the good stability over time of the mixture, in powder or liquid form; the compositions can consequently be stored for several weeks before use thereof, without the risk of impairment of their efficacy for processing sludge, as is clear from examples 3, 4 and 6 below.

As indicated above, the addition of lime gives rise to a high pH that in the majority of cases causes the inactivation or destruction of the organic polymers by alkaline hydrolysis during mixed use. In addition, the conjoint presence of lime and organic polymer may lead to a consumption of the latter for flocculating the lime, which is unnecessary and makes the polymer unavailable (see example 1). A person skilled in the art is therefore not led to use this type of polymer conjointly with lime, in particular in the form of a real composition (mixture), in order to overcome the deficiencies of the prior art for conditioning sludge.

In addition, nothing lets it be believed that a simple association comprising both lime and at least one organic coagulant for conditioning sludge may be sufficient, at the end of the mechanical dewatering step, for obtaining strong flocks and a degree of dryness superior to that achieved by use of the conventional methods and to afford savings in energy and/or conditioning agents (coagulant, lime), as shown by example 5.

Advantageously, the said cationic organic coagulant has a cationic charge greater than or equal to 4, preferably greater than or equal to 4.5 and in particular greater than or equal to 5 meq/g, the cationic charge advantageously being less than or equal to 10, preferably less than or equal to 9 meq/g, in particular less or equal to 7.5 meq/g.

Advantageously, the said polymer based on diallyldialkyl ammonium salts is a polymer based on compounds of general formula:

(CH2=CH—CH2)₂N⁺R₁R₂,X⁻

in which
X⁻ represents a halide or another negatively charged counter ion,
R₁ and R₂ represent independently of each other a hydrogen atom or a C₁ to C₁₀ alkyl chain.

In an advantageous embodiment, the said polymer is a polymer based on diallyl dimethyl ammonium chloride, also referred to as DADMAC.

The said linear or branched polymer based on diallyldialkyl ammonium salts may be a copolymer and comprise one or more other monomers chosen from the group consisting of non-ionic monomers, such as acrylamide, methacrylamide, N-vinyl pyrrolidone, vinyl acetate, vinyl alcohol, acrylate esters, allyl alcohol, N-vinyl acetamide or N-vinyl formamide, and cationic monomers such as dialkylaminoalkyl(meth)acrylate, dialkylaminoalkyl(meth)acrylamide, quaternary ammonium salts thereof or acid salts thereof such as for example dimethylaminoethyl acrylate (DMAEA), dimethylaminoethyl methacrylate (DMAEMA), quaternised or with the salt produced, acrylamidopropyltrimethylammonium chloride (APTAC) and methacrylamidopropyltrimethylammonium chloride (MAPTAC).

In a variant according to the invention, the said cationic organic coagulant comprises, in association with the cationic charges, anionic charges carried by anionic monomers, such as for example (meth)acrylic acid, acrylamidomethylpropane sulfonic acid, itaconic acid, maleic anhydride, maleic acid, vinyl sulfonic acid, methallyl sulfonic acid and salts thereof. In this way, the said organic coagulant may be of a very slightly amphoteric nature.

This polymer does not require the development of a particular polymerisation method. It can be obtained by all polymerisation techniques well known to persons skilled in the art: gel polymerisation, polymerisation by precipitation, polymerisation in emulsion (aqueous or inverse) followed or not by a distillation step, polymerisation in suspension, polymerisation in solution, these polymerisations being followed or not by a step for isolating a dry form of the (co)polymer by all types of means well known to persons skilled in the art.

Advantageously, in the composition according to the invention, the said cationic organic coagulant is present in a quantity ranging from 5 to 80 g (expressed as active material, namely as a polymer) and more preferably from 10 to 65 g for 1 kg of lime (expressed as slaked lime equivalent CA(OH)₂).

The size of the lime particles is not critical. They will in general be mainly (more than 90%) of a size greater than 0.5 μm and mainly less than 2 mm, or even 1 mm, preferably less that 500 μm.

Quicklime means a mineral solid matter the chemical composition of which is mainly calcium oxide CaO. Quicklime is commonly obtained by baking limestone, mainly consisting of CaCO₃, a few percents of which may remain in the lime. Quicklime may also contain impurities such as magnesium oxide MgO, silica SiO₂, silicate or alumina Al₂O₃, or even a hydration retarding agent, to the extent of a few percent. It is understood that the impurities are expressed in the aforementioned forms but may in reality appear in different phases.

Slaked lime or hydrated lime means a set of solid particles, principally in the form of calcium hydroxide Ca(OH)₂, obtained by “slaking”, sometimes referred to as “hydration”, of quicklime with water. This slaked lime may obviously contain the aforementioned impurities, issuing from the quicklime.

Slaked lime may be in powder form or in the form of a suspension.

Milk of lime means an aqueous suspension manufactured at the start from quicklime or hydrated lime. The liquid embodiments of the composition according to the invention are produced at the start from milks of lime.

As mentioned previously, the cationic organic coagulant used may also be branched or even cross linked preferably during (and/or possibly after) polymerisation, in the presence of a branching agent and optionally of a transfer agent.

Other embodiments of the composition according to the invention are indicated in the accompanying claims.

The invention also relates to a use of the aforementioned composition for conditioning sludge.

In addition, the invention relates to a use of the aforementioned composition for the pre-liming of sludge.

Pre-liming means the addition of a lime compound to a sludge before dewatering.

Other embodiments of the use according to the invention are indicated in the accompanying claims.

The invention also relates to a sludge dewatering method, comprising
addition of a composition as described previously, to sludge, in particular urban or industrial, to be treated, before dewatering of the latter,
conditioning of the said sludge to which the said composition has been added,
solid/liquid separation of the conditioned sludge, and collection of the solid issuing from the said separation.

In particular, according to the invention, the said filtration is performed by weight averages of a belt filter, a filter press or a centrifuge, preferably a filter press.

Generally, the dryness of the solid issuing from the dewatering lies in the range from 10% to 80%, and in particular from 10% to 50%, especially between 20% and 50% by weight.

In general, the composition according to the invention will be added to the sludge with a dosing that corresponds to liming rates (expressed as Ca(OH)₂) of 5% to 100%, in particular from 10% to 80%, especially from 15% to 60% with respect to the dry matter of the sludge.

Other embodiments of the method according to the invention are indicated in the accompanying claims.

Other features, details and advantages of the invention will emerge from the description given below, non-limitatively and with reference to the examples.

The cationic organic coagulants according to the invention used have an averageg molecular weight of less than 5 million g/mol and greater than or equal to 20,000 g/mol, preferably with an average molecular weight of less than 3 million g/mol and greater than or equal to 50,000 g/mol.

Preferably, the organic coagulants within the meaning of the invention have a cationic charge greater than or equal to 4 meq/g, in particular 4.5 meq/g, advantageously greater than or equal to 5 meq/g and less than or equal to 10, preferably less than or equal to 9 meq/g, in particular less than or equal to 7.5 meq/g.

These characteristics of the “coagulants” distinguish them from the cationic organic polymers, often referred to as “flocculents” and which have weight average molecular weights often much greater than 5 million g/mol and are said to be long chain. Their so-called long chain enables them to bridge other molecules, which confers on them their flocculent character.

Likewise, these characteristics of the “coagulants” distinguish them from dispersant organic polymers that generally have an anionic charge (in any event during use in association with lime) and the purpose of which is to enable the dispersion of a substance or particle within a liquid in which it is not soluble. The dispersant nature is mainly due to the repulsion between charges carried by the dispersant (negative) and the particles of the sludge (also negative) which prevents any agglomeration and maintains the dispersion between particles.

Through their nature, coagulants enable particles (colloids) in suspension to be destabilised by neutralising their charge (cancellation of the ZETA potential) in comparison with flocculents, which form real bridges between particles in order to produce flocks, namely agglomerates of destabilised particles.

### Example 1

### Formulation of a Poly-DADMAC/Lime Composition According to the Invention Versus Other Associations of Polymers and Limes

Three families of polymer are compared. In each family the most efficient polymer to be used is determined. Formulations are prepared by integration under agitation of the polymers tested, with suspensions of lime formulated at 300 g/dm³. For each formulation, dosages of 5% were effected, dosages expressed as a percentage of active matter of polymer with respect to the equivalent in the form of oxide CaO contained in the lime suspension.

TABLE 1

| | Commercial | | Molecular | | Dosage |
|---|---|---|---|---|---|
| Type of | name | | weight | Cationicity | (% by weight |
| polymer | (form) | Nature | (g/mole) | (meq/g) | MA/CaO) |
| Cationic | EM 840MBL | chloromethylated | 8 million | 4.73 | 5% |
| flocculent | (emulsion) | DMAEA acrylamide | | | |
| | | copolymer | | | |
| Anionic | EM 630 | acrylamide sodium | 20 million | NA | 5% |
| flocculent | (emulsion) | acrylate copolymer | | | |
| Cationic | FL4820 | DADMAC | 1 million | 6.2 | 5% |
| coagulant | (liquid) | homopolymer | | | |
| according | | | | | |
| to the | | | | | |
| invention | | | | | |

For each test performed, the appearance of the formulation was noted. The results are presented in table 2 below.

TABLE 2

| Test N° | 1 | 2 | 3 |
|---|---|---|---|
| Organic polymer | EM 840 MBL | EN 630 | FL4820 |
| Type | Cationic | Anionic | Cationic |
| | flocculent | flocculent | coagulant |
| Appearance of | Solidification/ | Solidification/ | Slight |
| suspension | not usable | not usable | modification of |
| | | | appearance of |
| | | | suspension |

As can be seen, the cationic coagulant composition of the poly-DADMAC/milk of lime type according to the invention is the only polymer/milk of lime combination that makes it possible obtain a suspension (no solidification).

### Example 2

### Advantage of a Composition According to the Invention Comprising Lime and Poly-DADMAC Versus Other Associations of Polymers and Lime

The tests are carried out on a pilot filtration unit installation. The installation comprises a stirred preparation vessel of 200 dm³, a transfer and charging pump and a filter press of the Netzsch type composed of 11 plates with a total filtering surface of 1 m².

The sludge, issuing from biological treatment, underwent a prior concentration treatment on a dewatering table. The concentration of dry matter of the sludge is 50 g/dm³.

Three families of polymer are compared. In each family the most efficient polymer and the preferred dose to be used are determined in advance; the dose is expressed as a percentage by weight of active matter (AM) with respect to the total weight of sludge dry matter (DM) (see table 3)

TABLE 3

| | Commercial | | Molecular | | Dosage |
|---|---|---|---|---|---|
| Type of | name | | weight | Cationicity | (% by weight |
| polymer | (form) | Nature | (g/mole) | (meq/g) | AM/DM) |
| Cationic | EM 840MBL | chloromethylated | 8 million | 4.73 | 0.7% |
| flocculent | (emulsion) | DMAEA acrylamide | | | |
| | | copolymer | | | |
| Anionic | EM 630 | acrylamide sodium | 20 million | NA | 0.3% |
| flocculent | (emulsion) | acrylate copolymer | | | |
| Cationic | TS45SH | DADMAC | 1 million | 6.2 | 1.5% |
| coagulant | (powder) | homopolymer | | | |

For the three polymers tested, 20 dm³ of a concentrated 10 g/dm³ solution is prepared in a stirred tank.

In a 200 dm³ stirred vessel, 100 dm³ of sludge is prepared and the quantity of slaked lime necessary in order to obtain a treatment rate of 34% is added thereto under stirring. The dosage expressed represents in % the quantity of reagent in dry equivalent (in Ca(OH)₂) with respect to the dry matter concentration of the sludge. For the first 2 polymers (tests 1 and 2), the lime is added to the sludge in the form of a 160 g/dm³ concentrated milk of lime. After the dispersion of the lime in the sludge, the predetermined quantity of polymer is added with reference to the concentrations illustrated in table 3 of each prepared polymer solution. For the last polymer (test n^{o} 3), the 10 g/dm³ solution is incorporated in the milk of lime (concentrated at 160 g/dm³ as for tests 1 and 2), in order to obtain a composition (suspension) according to the invention, which is added to the sludge.

The filtration cycle is then started. This is considered to be finished when the specific flow rate becomes less than 10 dm³/h/m² of filtering surface. The filtration cycle is stopped after two hours of filtration in all cases if the minimum specific rate is not reached. For each of the polymers tested, the suitability of the cakes formed for discharge from the filter is noted. A measurement of dryness (% dry matter) is also carried out on the cakes sampled after 24 hours in the oven at 105° C.

The results are presented in table 4 below.

TABLE 4

| Test n° | 1 | 2 | 3 |
|---|---|---|---|
| Organic polymer | EM 840 MBL | EN 630 | |
| | | | Milk of lime - TS |
| | | | 45SH composition |
| type | Cationic | Anionic | Cationic |
| | flocculent | flocculent | coagulant |
| Dryness cake (% DM) | 27% | 28% | 31% |
| Discharge from filter | Sticking | Sticking | OK |
| | cake | cake | |

As can be seen, the cationic coagulant composition of the poly-DADMAC/milk of lime type according to the invention (test 3) is the only polymer/milk of lime combination that makes it possible to obtain an optimised filtration cake dryness and good properties of discharging from the filter.

### Example 3

### Preparation of a Powdery Composition and Short-Term Stability

The operating conditions of example 2 are reproduced, but only the cationic coagulant (TS45SH, poly-DADMAC type) is used, at a dosage of 2% in this example (instead of 1.5% in example 2).

For the 2 tests of this example, use is made as a mineral component of a fine quicklime (<90 μm), partially slaked as disclosed in the patent EP 1 154 958, which is added in powdery form and at a dosage of 26% (of CaO per sludge DM, ie the same dosage in equivalent Ca(OH)₂ as in example 2).

The following preparation and injection variables are tested
Test 1: mixing of the coagulant in dry form and lime in powdery form and then injection of the mixture in the maturation vessel
Test 2: mixing of the coagulant in dry form with the lime in powdery form, storage of the mixture for 48 hours and then injection of the mixture in the maturation vessel.

The results of these tests are presented in table 5 below.

TABLE 5

| Test n° | 1 | 2 |
|---|---|---|
| Dryness cake (% DM) | 35% | 36% |
| Discharge from filter | OK | OK |

As can be seen, the 2 tests make it possible to obtain very high cake dryness and easy discharge from the filters. Test 2 also shows that the powdery composition ready for use is stable for at least 48 hours and keeps its effectiveness for the conditioning.

### Example 4

### Stability of the Composition in a Long Term Basis

The sludge, similar to the one in example 2, is conditioned in the laboratory by means of a powdery composition according to the invention containing an organic cationic coagulant (poly-DADMAC) and lime, the composition being either freshly formulated or used after a storage period of 2 months following its formulation.

The sludge is treated in a Faure filtration cell that simulates an industrial filtration on a filter press. The conditioning is carried out by introducing 2.5 dm³ of sludge into the filtration cell and the filtration takes place over 2 hours, observing a progressive rise in the pressure up to 15 bar in 30 minutes and then keeping the pressure for 1 hour at 15 bar. Next a measurement is made of the dry matter on the cakes formed after 24 hours in an oven at 105° C.

The powdery composition according to the invention is prepared in the following manner. In an asynchronous mixer (Hobart type), 1 kg of powdery lime of the type in example 3 is introduced, and then 50 g of TS45SH powder coagulant. The whole is mixed for 10 minutes. The results of the treatments are presented in table 6.

TABLE 6

| Test n° | 1 | 2 |
|---|---|---|
| Form of the composition | Powdery | Powdery |
| Storage of the composition | No | 2 months |
| according to the invention | | |
| Cake dryness (% DM) | 33% | 32% |
| Discharge from the filter | OK | OK |

Table 6 shows that the reagent formulated even after 2 months of storage keeps very good effectiveness.

### Example 5

### Comparison of the Performance of Compositions According to the Invention Compared with an Association of FeCl₃ and Lime

Three types of sludge

≈a biological sludge
≈an industrial sludge, and
≈a digested biological sludge
are conditioned in the laboratory by means of
on the one hand, optimised combinations of FeCl₃ and lime, and
on the other hand compositions of poly-DADMAC and lime, according to the invention.

The sludge are conditioned and then filtered in a Faure filtration cell, according to the operating protocol described in example 4.

The quantities of sludge produced are then calculated. Indeed the limitation on the operating costs and elimination of the sludge encourages the production of the least sludge possible and finding the best compromise between the final dryness and the quantities of conditioning reagents to be used.

In the dewatered sludge, there are the dry matter of product to be treated, the residual water and the conditioning agents.

To compare the performance of various conditioning operations, apart from the dryness, it is sought to estimate the quantity of sludge produced.

The following ratio is therefore defined:

Q=quantity of dewatered sludge/quantity of dry matter initially present in the sludge to be treated.

The results are illustrated in table 7

TABLE 7

| | Type of sludge | | | | | |
|---|---|---|---|---|---|---|
| | Biological sludge | | Industrial sludge | | Digested sludge | |
| | Test n^{o} | | | | | |
| | 1 | 2 | 3 | 4 | 5 | 6 |
| conditioning | FeCl₃ and | Poly-DADMAC | FeCl₃ and | Poly-DADMAC | FeCl₃ and | Poly-DADMAC |
| | milk of | and lime | powdery lime | and milk of | lime | and lime |
| | lime | composition | | lime | | composition |
| | | | | composition | | |
| Form of composition | | Suspension | | Powdery | | Suspension |
| Coagulant dosage | 8 | 1.5 | 8 | 1.5 | 5 | 1.0 |
| (% by weight) | | | | | | |
| Lime dosage | 30 | 30 | 20 | 15 | 26 | 26 |
| (% by weight) | | | | | | |
| Dryness obtained | 35 | 36 | 46 | 47 | 35 | 37 |
| (% DM) | | | | | | |
| Discharge from | OK | OK | OK | OK | OK | OK |
| filter | | | | | | |
| Quantity of sludge | 3.9 | 3.7 | 2.9 | 2.6 | 3.7 | 3.4 |
| produced (Q) | | | | | | |

As can be seen, the compositions according to the invention show in all cases better performance (see tests 2, 4 and 6 compared with the combination of FeCl₃ with lime—comparative tests: 1, 3 and 5).

The dryness of the cakes is systematically superior and the quantity of coagulant to be used is highly reduced, likewise it is sometimes also possible to reduce the dose of lime (whether in powder form or in the form of milk of lime).

The quantities of sludge produced are reduced (reduction of the doses of reagents+increase in dryness), which procures a significant advantage in operation and reduces the disposal costs of the sludge.

### Example 6

### Comparison of the Performance of the Composition According to the Invention Compared with a Composition Containing a Cationic Flocculent

A digested sludge is subjected to three types of conditioning presented in table 8 below.

This sludge is then filtered via a Faure filtration cell, according to an operating protocol identical to that presented in example 4.

The powdery composition of poly-DADMAC and lime according to the invention is prepared according to an operating protocol identical to the one presented in example 4. The mixture is stored for one week before use thereof.

The composition according to the invention of poly-DADMAC and lime in liquid form is obtained in the following way. In a stirred beaker, 1 kg concentrated milk of lime with 40% dry matter is introduced, and then 76.9 g of poly-DADMAC coagulant in liquid form and concentrated with 20% of dry matter is added. The whole was mixed for 10 minutes and then stored for 1 week. The suspension formulated has a lime concentration of 38.6%. After 1 week, the liquid mixture has slitly sedimented and keeps its pumpable character.

The results are presented in table 8.

TABLE 8

| Test n° | 1 | 2 | 3 |
|---|---|---|---|
| conditioning | Cationic | Poly-DADMAC | Poly-DADMAC |
| | flocculent | and lime | and lime |
| | | coagulant | coagulant |
| Form | Liquid | Powdery | Liquid |
| Dosage of processing | 1% | 20% | 26% |
| agent (% by weight) | | | |
| Dryness obtained | 19 | 30 | 37 |
| (% by weight DM) | | | |
| Discharging from | Sticky | OK | OK |
| filter | | | |
| Quantity of sludge | 5.4 | 4.2 | 3.4 |
| produced (Q) | | | |

As can be seen, the tests performed with the compositions according to the invention (poly-DADMAC and lime) make possible to greatly improve the dewatering performance and the discharge of the cake from the filter. Both the powder mixture and the liquid mixture show good stability (of formulation) after one week. No reduction in performance is noted compared with a freshly produced mixture. Compared with an organic processing, the poly-DADMAC/lime pair reduces the quantity of sludge produced. There is as much lime and poly-DADMAC in test 2 as test 3 since the dosage is expresed as Ca(OH)₂ in test 3.

### Example 7

### Advantage on Centrifuge

A biological sludge is subjected to two types of conditioning before dewatering on a centrifuge. The first conditioning comprises an addition of a cationic flocculent and powdery lime while the second conditioning comprises an addition of a cationic flocculent and a powdery composition according to the invention containing poly-DADMAC and lime.

For each conditioning the optimum dose of flocculent is optimised and the powdery lime used is similar to that in example 3. The powdery composition of poly-DADMAC and lime is a powdery mixture prepared as indicated in example 5.

There is added to the sludge either the lime (test 1) or the composition according to the invention, containing the poly-DADMAC and lime (test 2), and mixing is carried out before the addition of the cationic flocculent. The flocculated sludge is dewatered in accordance with a procedure simulating dewatering on a centrifuge. The results are present in table 9.

TABLE 9

| Test n° | 1 | 2 |
|---|---|---|
| Dosage of flocculent | 0.55 | 0.08 |
| (% by weight) | | |
| Reagent added | Lime | (poly-DADMAC and lime) |
| Form of reagent | powdery | powdery |
| Quantity of reagent | 30 | 30 |
| (% by weight) | | |
| Dryness obtained | 36 | 35 |

As can be seen, in association with a flocculent, the reagent formulated makes it possible to obtain filtration performance similar to a flocculent/lime conditioning, but the composition according to the invention makes it possible to reduce by 85% the dose of flocculent to be used. The composition according to the invention can therefore be used in combination with other mineral or organic conditioning agents.

Naturally the present invention is in no way limited to the embodiments described above and many modifications can be made thereto without departing from the scope of the accompanying claims.

For example, the composition according to the invention is supplied in a mixture ready for use on the site where it to be used. It is added in a single step to the sludge to be conditioned from a single reservoir. The lime and said at least one organic coagulant can also be introduced conjointly at two injection points, in particular premixed before introduction thereof into the sludge. The term “composition” employed here therefore for simplicity covers this variant, but in any event the conditioning according to the invention therefore does not necessarily require several steps since, as mentioned above, the composition is preferably added in a single step.

1. Sludge conditioning composition comprising a mineral compound and an organic compound, wherein said mineral compound is lime and said organic compound is selected from the group consisting of linear or branched polymers based on diallyl dialkyl ammonium salts, characterized in that said organic compound is a cationic organic coagulant having an average molecular weight less than or equal to 5 million g/mol and greater than or equal to 20,000 g/mol, present in a quantity ranging from 3 g to 100 g for 1 kg of lime expressed as a slaked lime Ca(OH)₂ equivalent, said composition being in the form of an homogeneous and stable mixture of lime and said coagulant before being introduced for conditioning sludge and in that said composition is in a stable suspension form, wherein said lime is slaked lime in the form of a milk of lime, and forms with said organic coagulant a stable suspension.

2. Composition according to claim 1, in which the said cationic organic coagulant has a cationic charge greater than or equal to 4 meq/g and less than or equal to 10 meq/g.

3. Composition according to claim 2, in which the said polymer based on diallyldialkyl ammonium salts is a polymer based on compounds of general formula:
(CH₂═CH—CH₂)₂N⁺R₁R₂,X⁻
in which
X⁻ represents a halide or another negatively charged counter ion,
R₁ and R₂ represent independently of each other a hydrogen atom or a C₁ to C₁₀ alkyl chain.

4. Composition according to claim 3, in which the said polymer is a diallyl dimethyl ammonium chloride polymer.

5. Composition according to claim 4, in which the said linear or branched polymer based on diallyldialkyl ammonium salts is a copolymer and comprises one or more other monomers selected from the group consisting of non-ionic monomers, including acrylamide, methacrylamide, N-vinyl pyrrolidone, vinyl acetate, vinyl alcohol, acrylate esters, allyl alcohol, N-vinyl acetamide or N-vinyl formamide, and cationic monomers including dialkylaminoalkyl(meth)acrylate, dialkylaminoalkyl(meth)acrylamide, quaternary ammonium salts thereof or acid salts thereof including dimethylaminoethyl acrylate (DMAEA), dimethylaminoethyl methacrylate (DMAEMA), quaternised or with the salt produced, acrylamidopropyltrimethylammonium chloride (APTAC) and methacrylamidopropyltrimethylammonium chloride (MAPTAC).

6. Composition according to claim 5, in which the said cationic organic coagulant comprises, in association with the cationic charges, anionic charges carried by anionic monomers, including (meth)acrylic acid, acrylamidomethylpropane sulfonic acid, itaconic acid, maleic anhydride, maleic acid, vinyl sulfonic acid, methallyl sulfonic acid and salts thereof.

7. Composition according to claim 1, in which the said cationic organic coagulant is present in a quantity ranging from 3 g to 100 g—for 1 kg of lime expressed as a slaked lime Ca(OH)₂ equivalent.

8. The composition of claim 1, wherein the composition is used for conditioning sludge by addition of the composition in a conditioning step.

9. The composition of claim 8, wherein the composition is used for the pre-liming of sludge by addition of the composition in a pre-liming step.

10. Sludge dewatering method, comprising:
addition of a composition according to claim 1 to a municipal or industrial sludge to be conditioned before dewatering of the latter;
conditioning of the said sludge to which the said composition has been added;
filtration of the sludge thus conditioned and collection of the solid issuing from the said filtration.

11. Method according to claim 10, in which the said filtration is performed by means of a belt filter, a filter press or a centrifuge and preferably a filter press.

12. Method according to claim 11, in which the dryness of the solid issuing from the said filtration is in the range from 10% to 80% by weight, said composition being added to the sludge at a dosing which corresponds to liming rates expressed as Ca(OH)₂, of from 5 to 100% with respect to dry matter of the sludge.

13. Composition according to claim 1, in which the said cationic organic coagulant has a cationic charge greater than or equal to 4.5 meq/g and less than or equal to 9 meq/g.

14. Composition according to claim 1, in which the said cationic organic coagulant has a cationic charge greater than or equal to 5 meq/g and less than or equal to 7.5 meq/g.

15. Composition according to claim 14, in which the said cationic organic coagulant is present in a quantity ranging from 5 to 80 g for 1 kg of lime, expressed as a slaked lime Ca(OH)₂ equivalent.

16. Composition according to claim 14, in which the said cationic organic coagulant is present in a quantity ranging from 10 to 65 g for 1 kg of lime, expressed as a slaked lime Ca(OH)₂ equivalent.

17. Method according to claim 11, in which dryness of the solid issuing from the said filtration is in the range from 10% to 50% by weight, said composition being added to the sludge at a dosing which corresponds to liming rates, expressed as Ca(OH)₂, of from 10% to 80%, with respect to dry matter of the sludge.

18. Method according to claim 11, in which dryness of the solid issuing from the said filtration is in the range from 20% to 50% by weight, said composition being added to the sludge at a dosing which corresponds to liming rates, expressed as Ca(OH)₂, of from 15% to 60% with respect to dry matter of the sludge.
